(19) United States
(12) Patent Application Publication
(10) Pub. No.: US 2025/0035297 A1
(43) Pub. Date: Jan. 30, 2025

(54) LIGHTING APPARATUS

(71) Applicant: LEEDARSON LIGHTING CO.,LTD., Zhangzhou (CN)

(72) Inventors: Shenggan Wang, Zhangzhou (CN); Huitang Zhang, Zhangzhou (CN); Yongzhe Dong, Zhangzhou (CN); Ping Yan, Zhangzhou (CN); Yange Su, Zhangzhou (CN); Linhua Wang, Zhangzhou (CN)

(21) Appl. No.: 18/784,891

(22) Filed: Jul. 25, 2024

(30) Foreign Application Priority Data
Jul. 27, 2023 (CN) 202322008922.4

(51) Int. Cl. F21V 25/12; F21S 8/02; F21V 23/00; F21V 23/04; F21Y 115/10; G08B 17/06

(52) U.S. Cl. CPC F21V 25/12; F21S 8/028; F21V 23/001; F21V 23/005; F21V 23/008; F21V 23/04; G08B 17/06; F21Y 2115/10

(57) ABSTRACT

A lighting apparatus includes a back cover, an annular structure and a light module. The annular structure has surrounding wall. The surrounding wall defines a top opening. The back cover conceals the top opening. The annular structure has a bottom rim extended outwardly from a bottom border of the surrounding wall. The annular structure and the back cover are fixed as a unit to conceal the installation opening. The annular structure and the back cover are made of a fireproof material. The back cover and the annular structure defines a container space. The light module is stored within the container space. The surface rim conceals the installation opening. The bottom ring is between the surface rim and an edge border of the installation opening.

### FIELD

The present invention is related to a lighting apparatus, and more particularly related to a lighting apparatus with fireproof function.

### BACKGROUND

LED technology has revolutionized the lighting industry, becoming a preferred choice for various light device designs due to its numerous advantages. Initially, the adoption of LED light devices was driven primarily by their high energy conversion ratio. LEDs convert a higher percentage of electrical energy into light compared to traditional incandescent and fluorescent lights, resulting in significant energy savings. This efficiency not only reduces electricity bills for consumers but also contributes to environmental conservation by lowering overall energy consumption.

As LED technology advanced, its benefits extended beyond just energy efficiency. Consumers and designers began to appreciate the flexibility and versatility of LEDs in producing a wide range of lighting effects. Unlike traditional lighting solutions, LEDs can be easily controlled and manipulated to create different colors, intensities, and patterns of light. This capability has opened up new possibilities for innovative lighting designs in various settings, from residential and commercial spaces to artistic and architectural installations.

One of the key features that make LEDs so appealing is their ability to produce dynamic lighting effects. With the use of smart controllers and programming, LEDs can change colors, brightness, and patterns in real-time. This flexibility allows for the creation of customized lighting scenes that can enhance the ambiance of a space, improve mood, and even influence behavior. For instance, LED lighting can be programmed to simulate natural daylight cycles, promoting better sleep and well-being in residential environments or to create an engaging and vibrant atmosphere in retail and entertainment venues.

Moreover, the compact size and durability of LEDs have made them ideal for a wide range of applications. LEDs can be integrated into various form factors, from small, discrete components to large-scale lighting arrays. This adaptability has led to their widespread use in everything from household light bulbs to street lighting, automotive lighting, and even intricate display systems. The long lifespan of LEDs also reduces maintenance costs and the frequency of replacements, further enhancing their appeal to both consumers and commercial users.

In addition to their practical benefits, LEDs are also contributing to advancements in smart lighting and the Internet of Things (IoT). Modern LED light devices can be connected to smart home systems and controlled via smartphones, voice assistants, and automation platforms. This connectivity allows users to tailor their lighting environments with unprecedented ease and precision, integrating lighting control into broader smart home ecosystems. As a result, LED technology continues to push the boundaries of what is possible in lighting design, offering both functional and aesthetic improvements that meet the evolving needs of modern society.

Lighting devices are ubiquitous in modern environments, found in residential homes, commercial buildings, industrial facilities, and public spaces. Their essential role in providing illumination makes them integral to daily life and work, with applications ranging from basic lighting to complex, automated lighting systems. As technology advances, the design and functionality of light devices continue to evolve, offering enhanced efficiency, better aesthetics, and improved user experiences.

However, the presence of lighting devices in virtually every environment also introduces significant fire safety concerns. Lighting fixtures can become a source of fire hazards due to various factors, including electrical faults, overheating, and improper installation. Once a fire starts, it can rapidly spread through a building, leading to extensive damage, potential loss of life, and significant economic costs. The risks associated with fire accidents are particularly high in densely populated areas, high-rise buildings, and industrial settings, where the consequences of a fire can be catastrophic.

To mitigate these risks, numerous fire safety standards and regulations have been established, mandating that lighting devices adhere to stringent safety criteria. These standards are designed to ensure that lighting fixtures do not contribute to the initiation or spread of fire. Compliance with these standards often requires the use of fire-resistant materials, proper electrical insulation, and design features that prevent overheating and electrical faults.

Despite the critical importance of these safety measures, the cost of implementing them can be substantial. High-quality fire-resistant materials and advanced safety features can significantly increase the production and installation costs of lighting devices. This financial burden can be particularly challenging for manufacturers, property developers, and consumers, who must balance the need for safety with budget constraints. Consequently, there is a pressing need for cost-effective solutions that do not compromise on fire safety standards.

A key aspect of fire safety in lighting device design is preventing the propagation of fire through the installation pathways of these devices. When a fire starts, it can easily travel through conduits, ceiling spaces, and other pathways connected to lighting fixtures, spreading to other parts of the building. This can complicate firefighting efforts and exacerbate the damage caused by the fire. Therefore, it is crucial to design lighting devices and their installation systems in a way that prevents fire from entering or spreading through these pathways.

Addressing this challenge requires innovative design approaches that incorporate fire barriers and seals within the lighting fixture installation. These barriers can help contain a fire within a specific area, preventing it from reaching other spaces through the lighting installation paths. Such measures are essential in maintaining the integrity of fire compartments within buildings, ensuring that fire does not spread unchecked.

Furthermore, while fire safety is paramount, the solution must also be practical and affordable. There is a need for designs that can be easily integrated into existing lighting systems without requiring significant modifications or additional costs. This balance between safety and cost-efficiency is critical for widespread adoption and compliance with fire safety regulations.

In summary, the widespread use of lighting devices in various environments necessitates robust fire safety measures to prevent fire accidents and their potentially devastating consequences. While current safety standards provide a framework for safe design, the associated costs can be a barrier. Therefore, developing cost-effective solutions that maintain high safety standards is essential. A key focus should be on preventing the spread of fire through lighting installation pathways, ensuring that fires are contained and do not compromise the safety of the entire building.

### SUMMARY

In some embodiments, a lighting apparatus includes a back cover, an annular structure and a light module.

The annular structure has surrounding wall. The surrounding wall defines a top opening. The back cover conceals the top opening.

The annular structure has a bottom rim extended outwardly from a bottom border of the surrounding wall.

The annular structure and the back cover are fixed as a unit to conceal the installation opening. The annular structure and the back cover are made of a fireproof material.

The back cover and the annular structure defines a container space. The light module is stored within the container space.

The surface rim conceals the installation opening. The bottom ring is between the surface rim and an edge border of the installation opening.

In some embodiments, the lighting apparatus may also include a fire isolation layer placed between the back cover and the light module.

In some embodiments, the fire isolation layer is fixed to the back cover with a metal connector.

In some embodiments, the annular structure is a circular shape.

In some embodiments, the annular structure is polygonal shape.

In some embodiments, the light module includes a light source plate and multiple LED modules.

The multiple LED modules are mounted on the light source plate.

The multiple LED modules have multiple different optical parameters.

In some embodiments, the lighting apparatus may also include a controller for controlling driving currents supplied to the multiple LED modules to mix a required optical parameter.

In some embodiments, the controller is disposed on the light source plate.

In some embodiments, the controller is disposed in a driver box.

The driver box contains a driver circuit for converting an external power to driving currents.

The controller controls the driver circuit.

In some embodiments, there is a cable opening on back cover.

There is a cover sealing plate for concealing the cable opening while allowing the multiple LED modules to receive power supply from the cable opening.

In some embodiments, the cable sealing plate is made of a fireproof material.

In some embodiments, a manual switch is disposed on the driver box for a user to configure a mixed optical parameter of the multiple LED modules.

In some embodiments, when the light module is burnt with a fire, a distance between the light module and the back cover is changed by detaching the light module from the back cover by melting a fixing connector by the fire.

In some embodiments, then the fixing connector is melt, there is a hanging connector to prevent the light module directly dropping down to ground.

In some embodiments, a breaking sensor is coupled to a controller that controls the light module to send a fire alarm to an external device when the sensor detects melting of the fixing connector.

In some embodiments, a safety switch is turned on after the lighting apparatus is installed to turn on the fire alarm function of the breaking sensor.

In some embodiments, a socket connector is disposed on the back cover.

An external cable is guiding power to the light module via the socket connector.

In some embodiments, the fireproof material includes metal material.

In some embodiments, the surface rim is made of plastic material.

In some embodiments, the surface rim has a lower melting point than the annular structure.

### BRIEF DESCRIPTION OF DRAWINGS

FIG. 1 illustrates a lighting apparatus embodiment.

FIG. 2 illustrates an exploded new of a lighting apparatus.

FIG. 3 illustrates a cross sectional view of a lighting apparatus embodiment.

FIG. 4 illustrates a ring component example.

FIG. 5 illustrates a component example.

FIG. 6 illustrates a zoom-up view of a connection structure of components.

FIG. 7 illustrates a zoom-up view of a connection structure of another position.

FIG. 8 illustrates another lighting apparatus embodiment.

FIG. 9 shows a top view of the annular structure position.

FIG. 10A and FIG. 10B show two statuses of two components in an embodiments.

### DETAILED DESCRIPTION

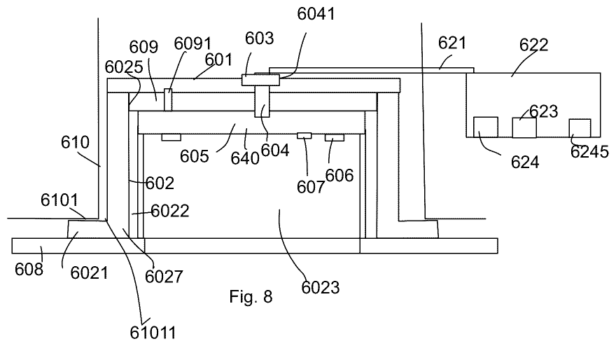

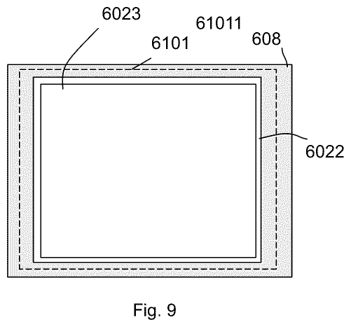

FIG. 8 shows a cross-sectional view of a lighting apparatus embodiment. FIG. 9 shows a top view for illustrating a relative position and size of an annual structure which is an example in the embodiment illustrated in FIG. 8 in view of an installation opening of an installation platform.

In FIG. 8, a lighting apparatus includes a back cover 601, an annular structure 602 and a light module 640. The lighting apparatus is to be installed to an installation platform, for example, which a cavity on the ceiling for inserting a portion of the lighting apparatus into the cavity while leaving a light opening to emit light downwardly.

FIG. 8 and FIG. 9 shows an edge border 6101 of an installation platform that defines an installation cavity 61011. For the case of a cavity of the ceiling above, the installation cavity would be the opening of the cavity.

The installation cavity in this case is a square shape, as illustrated in FIG. 9, but it may be other geometric shape, like a ring shape illustrated in other examples described below.

The annular structure 60 has surrounding wall 6022. The surrounding wall 6022 defines a top opening 6025. The back cover 601 conceals the top opening 6025.

The annular structure 602 has a bottom rim 6021 extended outwardly from a bottom border 6027 of the surrounding wall 6022.

The annular structure 602 and the back cover 601 are fixed as a unit to conceal the installation opening 61011. The annular structure 608 and the back cover 601 are made of a fireproof material.

The back cover 601 and the annular structure 602 defines a container space 6023. The light module 640 is stored within the container space 6023.

The surface rim 608 that is a part of a light housing which further is used for dispose the light module 640 in this example conceals the installation opening 61011, too. The bottom ring 6021 of the annular structure 602 is between the surface rim 608 and an edge border 6101 of the installation opening.

In some embodiments, the lighting apparatus may also include a fire isolation layer 609 placed between the back cover 601 and the light module 640.

In some embodiments, the fire isolation layer 609 is fixed to the back cover with a metal connector 6091.

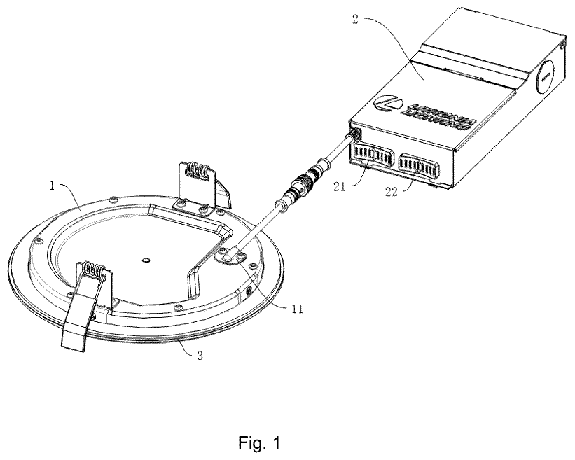

In some embodiments, the annular structure is a circular shape, as illustrated in the examples of FIG. 1 to FIG. 7.

In some embodiments, the annular structure is polygonal shape, like the example illustrated in FIG. 8 and FIG. 9.

In some embodiments, the light module 640 includes a light source plate 605 and multiple LED modules 606.

The multiple LED modules 606 are mounted on the light source plate 605.

The multiple LED modules 606 have multiple different optical parameters, e.g. different color temperatures. With proper control these LED modules 606 may be supplied with different ratio of driving currents to generate mixed lights of different optical parameters.

In some embodiments, the lighting apparatus may also include a controller 607 for controlling driving currents supplied to the multiple LED modules 606 to mix a required optical parameter.

In some embodiments, the controller 606 is disposed on the light source plate 605.

In some embodiments, the controller 624 is disposed in a driver box 622.

The driver box 622 contains a driver circuit 623 for converting an external power to driving currents.

The controller 624 controls the driver circuit 623.

In some embodiments, there is a cable opening 6014 on back cover 601.

There is a cover sealing plate 603 for concealing the cable opening 6041 while allowing the multiple LED modules to receive power supply from the cable opening 6041.

In some embodiments, the cable sealing plate 603 is made of a fireproof material.

In some embodiments, a manual switch 6245 is disposed on the driver box 622 for a user to configure a mixed optical parameter of the multiple LED modules.

In some embodiments, when the light module is burnt with a fire, a distance between the light module and the back cover is changed by detaching the light module from the back cover by melting a fixing connector by the fire.

In some embodiments, then the fixing connector is melt, there is a hanging connector to prevent the light module directly dropping down to ground.

In some embodiments, a breaking sensor is coupled to a controller that controls the light module to send a fire alarm to an external device when the sensor detects melting of the fixing connector.

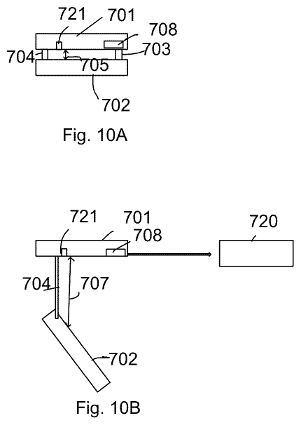

FIG. 10A and FIG. 10B show an example to demonstrate this idea.

The light module 702 is originally fixed to the back cover 701 with a fixing connector 703 and a hanging connector 703. When the fixing connector 703 is burnt which has a lower melting point than the hanging connector 707, the fixing connector 703 is melt and the connection between the light module 702 and the back cover 701 is detached partially.

The distance 705 between the light module 702 and the back cover 701 is changed to the new distance 707 when the fixing connector 703 is broken.

The hanging connector 704 which maybe made of metal spring or belt, may keep the light module 702 from falling down while making the distance 707 between the light module and back cover 701 farther, which may prevent fire to have better chance to extend into the installation platform that leads to other areas of a house or an office building.

In some embodiments, a safety switch 721 is turned on after the lighting apparatus is installed to turn on the fire alarm function of the breaking sensor 708.

The breaking senor 708 detects whether the fixing connector 703 is broken, e.g. use a small metal connection route to detect whether circuit loop is open or close.

In FIG. 8, a socket connector 604 is disposed on the back cover 601.

An external cable 621 is guiding power to the light module 640 via the socket connector 604.

In some embodiments, the fireproof material includes metal material.

In some embodiments, the surface rim is made of plastic material.

In some embodiments, the surface rim has a lower melting point than the annular structure.

Please refer to FIG. 1 to FIG. 5 as we describe the fireproof downlight provided by this utility model. The fireproof downlight includes a lamp housing 1, a face ring 3, and a flange 5. The lamp housing 1 is designed to be placed within the installation hole 110 of the installation object 100; the bottom surface of the lamp housing 1 is an open face. The upper surface of the lamp housing 1 is equipped with a wire clip 11, which connects to the power supply assembly 2. The face ring 3 includes a ring plate 31 and a ring platform 32 set on the ring plate 31. The ring platform 32 extends into the interior of the lamp housing 1 and connects to it. There is a radial installation space 12 between the ring platform 32 and the side wall of the lamp housing 1. The ring plate 31 is positioned within the installation hole 110, and the outer edge of the ring plate 31 extends to the periphery of the installation hole 110. There is an axial installation space 13 between the ring plate 31 and the top wall of the lamp housing 1. A light-emitting module 4 is set within the axial installation space 13. The flange 5 is placed within the radial installation space 12, extending its outer edge to the periphery of the installation hole 110, with the extension part located between the ring plate 31 and the bottom surface of the installation object 100. The lamp housing 1, the flange 5, and the wire clip 11 are made of fireproof material.

It should be noted that the fireproof downlight provided by this embodiment is generally installed on the ceiling, so the aforementioned installation object 100 is the ceiling, with the installation hole 110 mentioned above opened in the ceiling. The lamp housing 1 is placed inside the installation hole 110, and it also has two sets of spring arms that fix the fireproof downlight to the ceiling. The power supply assembly 2 is set on the top surface of the ceiling, concealed by the ceiling. The face ring 3 covers the installation hole 110 and serves a decorative function.

Compared with the prior art, the fireproof downlight provided by this utility model has the light-emitting module 4 set between the ring plate 31 of the face ring 3 and the top wall of the lamp housing 1. The flange 5 is placed between the ring platform 32 of the face ring 3 and the side wall of the lamp housing 1, with the extension part of the flange 5 positioned between the ring plate 31 and the bottom surface of the installation object 100. The flange 5 can isolate the light-emitting module 4 from the installation object 100. Additionally, the lamp housing 1, the flange 5, and the wire clip 11 are made of fireproof materials, forming a fireproof barrier within the installation hole 110 of the installation object 100. This setup can prevent fire from spreading into the interior of the installation object 100, reducing the risk of a fire starting inside the installation object 100.

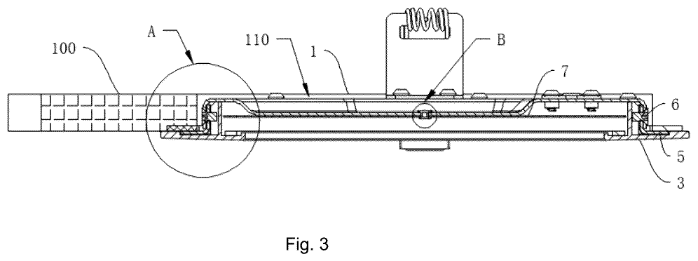

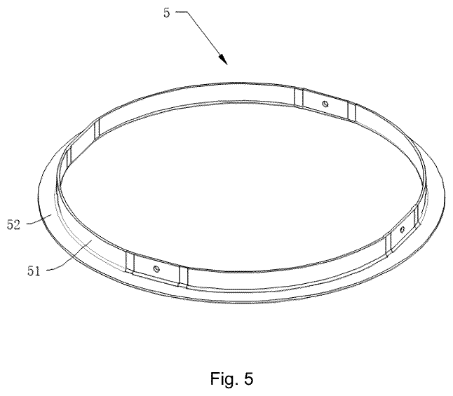

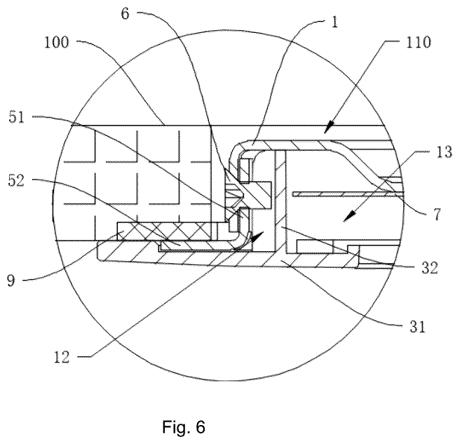

In some embodiments, the flange 5 can adopt the structure shown in FIG. 3, FIG. 5, and FIG. 6. Refer to FIG. 3, FIG. 5, and FIG. 6. The flange 5 includes an axial ring portion 51 and a radial ring portion 52. The axial ring portion 51 is placed within the radial installation space 12, and it is connected to the side wall of the lamp housing 1 using a first fastener 6. The radial ring portion 52 is formed at the bottom end of the axial ring portion 51 and extends to the periphery of the installation hole 110. The radial ring portion 52 is situated between the ring plate 31 and the bottom surface of the installation object 100.

The axial ring portion 51 is used to isolate the light-emitting module 4 from the installation hole 110, while the radial ring portion 52 isolates the face ring 3 from the installation object 100. The flange 5, which includes the axial ring portion 51 and the radial ring portion 52, features a simple structure, making it easy to manufacture.

In this embodiment, the flange 5 and the lamp housing 1 are separate parts, and the axial ring portion 51 of the flange 5 is connected to the side wall of the lamp housing 1 using the first fastener 6. This allows the flange 5 to be installed inside the lamp housing 1 without modifying the existing lamp housing 1, enhancing the fireproof performance of the fireproof downlight while simplifying the structure of the lamp housing 1 and the flange 5, and reducing production costs.

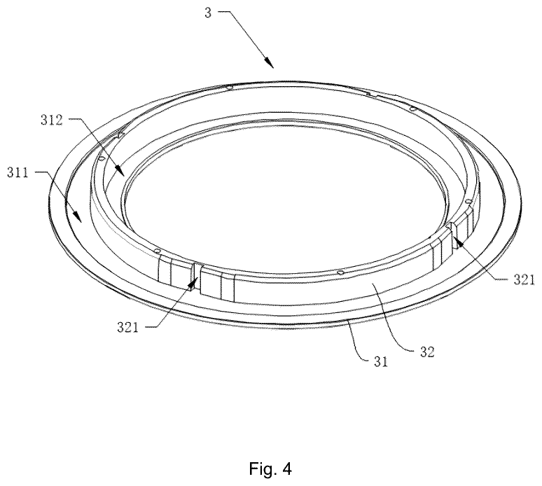

To facilitate the assembly of the first fastener 6, refer to FIG. 4 and FIG. 6. Based on the above embodiment, the outer side surface of the ring platform 32 is provided with a clearance groove 321. One end of the first fastener 6 sequentially passes through the side wall of the lamp housing 1 and the axial ring portion 51 and is placed within the clearance groove 321.

Preferably, the first fastener 6 is a screw. The first fastener 6 sequentially passes through the side wall of the lamp housing 1 and the axial ring portion 51 along the radial direction of the lamp housing 1. The clearance groove 321 is designed on the ring platform 32 to accommodate the entry end of the first fastener 6. This design can extend the length of the first fastener 6, enhancing its connection stability and thereby improving the assembly stability between the lamp housing 1 and the flange 5. The other end of the first fastener 6 is embedded in the outer side wall of the lamp housing 1.

It should be noted that multiple first fasteners 6 are arranged circumferentially around the lamp housing 1. Correspondingly, multiple clearance grooves 321 are provided on the ring platform 32.

In some embodiments, the connection between the face ring 3 and the flange 5 can adopt the structure shown in FIG. 3 and FIG. 4. Refer to FIG. 3 and FIG. 4. The upper surface of the ring plate 31 is provided with a downward-recessed first annular groove 311. The first annular groove 311 is located on the periphery of the ring platform 32. The radial ring portion 52 is placed within the first annular groove 311, and the upper surface of the radial ring portion 52 is flush with the upper surface of the ring plate 31.

By placing the radial ring portion 52 within the first annular groove 311, it avoids exposing the radial ring portion 52 directly below the installation object 100, which could affect aesthetics. Moreover, it ensures that the ring plate 31 contacts the bottom surface of the installation object 100, preventing gaps that could allow dust and other debris to enter the interior of the face ring 3.

In some embodiments, the face ring 3 can also adopt the structure shown in FIG. 3 and FIG. 4. Refer to FIG. 3 and FIG. 4. The upper surface of the ring plate 31 is provided with a downward-recessed second annular groove 312. The ring platform 32 is located on the periphery of the second annular groove 312. An inner foam 8 is placed within the second annular groove 312, and the inner foam 8 contacts the light-emitting module 4.

The second annular groove 312 is used to house the inner foam 8. The inner foam 8, in contact with the light-emitting module 4, prevents direct contact between the light-emitting module 4 and the face ring 3, thereby reducing wear and extending the service life of the face ring 3. Additionally, the inner foam 8 enhances the waterproof, moisture-proof, and vibration isolation properties between the face ring 3 and the light-emitting module 4.

Furthermore, outer foam 9 is provided between the upper surface of the radial ring portion 52, the upper surface of the ring plate 31, and the lower surface of the installation object 100. This outer foam 9 improves the waterproof and moisture-proof performance of the flange 5 and the face ring 3.

In some embodiments, the fireproof downlight can also adopt the structure shown in FIG. 3. Refer to FIG. 3. An insulating member 7 is provided within the axial installation space 13, positioned above the light-emitting module 4. The insulating member 7 further isolates flames generated by the light-emitting module 4 in case of fire, blocking heat and reducing the likelihood of combustion within the installation object 100.

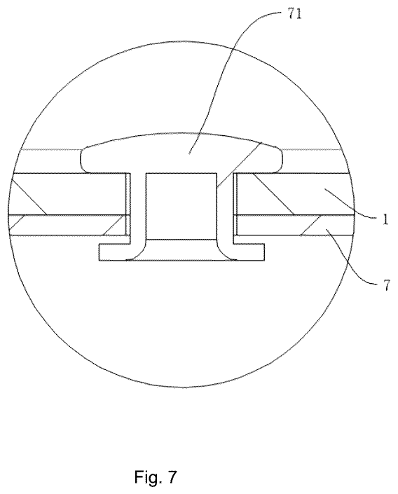

Preferably, the insulating member 7 is connected to the top wall of the lamp housing 1 using a second fastener 71, as shown in FIG. 7. The second fastener 71 sequentially passes through the top wall of the lamp housing 1 and the insulating member 7 along the axial direction of the lamp housing 1, as shown in FIG. 7. Preferably, the second fastener 71 is a rivet made of fireproof material.

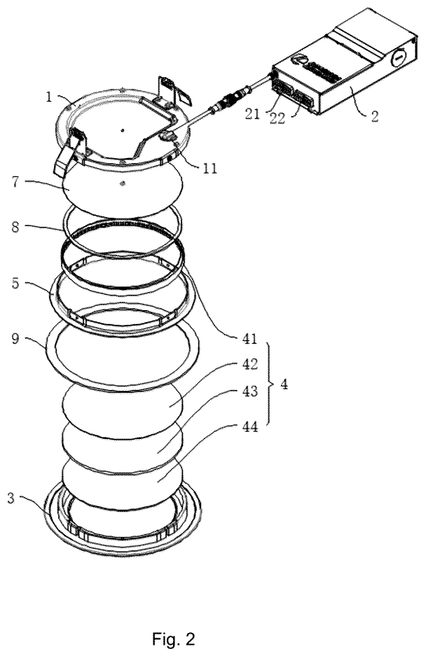

In some embodiments, the power supply assembly 2 can adopt the structure shown in FIG. 1 and FIG. 2. Refer to FIG. 1 and FIG. 2. The outer surface of the power supply assembly 2 is provided with a power adjustment switch 21 and a color temperature adjustment switch 22.

The inclusion of the power adjustment switch 21 and the color temperature adjustment switch 22 on the power supply assembly 2 allows the fireproof downlight to feature dial-based adjustments for color temperature and power, offering users more customization options.

Placing the power adjustment switch 21 and the color temperature adjustment switch 22 on the power supply assembly 2, rather than on the lamp housing 1, reduces the height of the lamp housing 1 and minimizes the number of connecting wires between the light-emitting module 4 and the power supply assembly 2.

In some embodiments, the light-emitting module 4 can adopt the structure shown in FIG. 2. Refer to FIG. 2. The light-emitting module 4 includes a light source assembly 41 and, sequentially stacked from top to bottom within the light source assembly 41, a reflective sheet 42, a light guide plate 43, and a diffuser plate 44.

The light source assembly 41 includes an annular strip and multiple LEDs arranged on the inner side wall of the annular strip. The reflective sheet 42 is positioned below the light source assembly 41 to reflect light emitted by the LEDs, increasing the path of the emitted light. Since the LEDs are located on the inner side wall of the annular strip, they emit side light, which the light guide plate 43 converts into a surface light source for uniform illumination. The diffuser plate 44 diffuses the light, increasing the area of emitted light.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus to be installed into a platform that has an installation opening, comprising:
a back cover;
an annular structure, wherein the annular structure has surrounding wall, wherein the surrounding wall defines a top opening, wherein the back cover conceals the top opening, wherein the annular structure has a bottom rim extended outwardly from a bottom border of the surrounding wall, wherein the annular structure and the back cover are fixed as a unit to conceal the installation opening, wherein the annular structure and the back cover are made of a fireproof material, wherein the back cover and the annular structure defines a container space;
a light module stored within the container space; and
a surface rim conceals the installation opening, wherein the bottom ring is between the surface rim and an edge border of the installation opening.

2. The lighting apparatus of claim 1, further comprising a fire isolation layer placed between the back cover and the light module.

3. The lighting apparatus of claim 2, wherein the fire isolation layer is fixed to the back cover with a metal connector.

4. The lighting apparatus of claim 1, wherein the annular structure is a circular shape.

5. The lighting apparatus of claim 1, wherein the annular structure is polygonal shape.

6. The lighting apparatus of claim 1, wherein the light module comprises a light source plate and multiple LED modules, wherein the multiple LED modules are mounted on the light source plate, wherein the multiple LED modules have multiple different optical parameters.

7. The lighting apparatus of claim 6, further comprising a controller for controlling driving currents supplied to the multiple LED modules to mix a required optical parameter.

8. The lighting apparatus of claim 7, wherein the controller is disposed on the light source plate.

9. The lighting apparatus of claim 7, wherein the controller is disposed in a driver box, wherein the driver box contains a driver circuit for converting an external power to driving currents, wherein the controller controls the driver circuit.

10. The lighting apparatus of claim 9, wherein there is a cable opening on back cover, wherein there is a cover sealing plate for concealing the cable opening while allowing the multiple LED modules to receive power supply from the cable opening.

11. The lighting apparatus of claim 10, wherein the cable sealing plate is made of a fireproof material.

12. The lighting apparatus of claim 9, wherein a manual switch is disposed on the driver box for a user to configure a mixed optical parameter of the multiple LED modules.

13. The lighting apparatus of claim 1, wherein when the light module is burnt with a fire, a distance between the light module and the back cover is changed by detaching the light module from the back cover by melting a fixing connector by the fire.

14. The lighting apparatus of claim 13, wherein then the fixing connector is melt, there is a hanging connector to prevent the light module directly dropping down to ground.

15. The lighting apparatus of claim 13, wherein a breaking sensor is coupled to a controller that controls the light module to send a fire alarm to an external device when the sensor detects melting of the fixing connector.

16. The lighting apparatus of claim 15, wherein a safety switch is turned on after the lighting apparatus is installed to turn on the fire alarm function of the breaking sensor.

17. The lighting apparatus of claim 1, wherein a socket connector is disposed on the back cover, wherein an external cable is guiding power to the light module via the socket connector.

18. The lighting apparatus of claim 1, wherein the fireproof material comprises metal material.

19. The lighting apparatus of claim 18, wherein the surface rim is made of plastic material.

20. The lighting apparatus of claim 18, wherein the surface rim has a lower melting point than the annular structure.
